(19) United States
(12) Patent Application Publication
(10) Pub. No.: US 2007/0282632 A1
(43) Pub. Date: Dec. 6, 2007

(54) Method and apparatus for serving advertisements in an electronic medical record system

(76) Inventor: Eric Sachs, Newark, CA (US)

Correspondence Address: PARK, VAUGHAN & FLEMING LLP, 2820 FIFTH STREET, DAVIS, CA, 95618-7759, US

(21) Appl. No.: 11/443,818

(22) Filed: May 30, 2006

(51) Int. Cl. G06F 19/00; G07G 1/14

(52) U.S. Cl. 705/3; 705/14

(57) ABSTRACT

One embodiment of the present invention provides a system that serves advertisements within an electronic medical record (EMR) system. During operation, the system receives a request from a medical practitioner to access a patient-record from the EMR system. Next, the system looks up the patient-record in the EMR system and obtains one or more advertisements based information associated with the patient-record. The system then displays the one or more advertisements along with the patient-record to the medical practitioner.

### BACKGROUND

1. Field of the Invention

The present invention relates generally to computer-based medical record systems. More specifically, the present invention relates to a method and an apparatus for serving advertisements in an electronic medical record (EMR) system.

2. Related Art

Advances in computer technologies have led to the development of electronic medical record (EMR) systems, which provide a wide range of capabilities that can greatly improve the quality of patient care. For example, EMR systems can allow medical practitioners to access patient data from any given location, and can facilitate automated checks for drug and allergy interactions. They can also be used to avoid unnecessary medical tests and procedures. Because of these benefits, wide-scale deployment of EMRs can potentially address the ballooning costs of medical care, which account for nearly 15% of the United States' Gross Domestic Product (GDP).

Unfortunately, medical providers have been slow to adopt EMR systems because they are expensive to deploy, and they do not provide a strong return on investment for the medical providers themselves. In fact, because EMR systems often eliminate tests and procedures, they can actually reduce the amount of money that a medical provider receives. Hence, what is needed are financial incentives to match the significant benefits provided by EMR systems.

Another problem in the medical field is that doctors get bombarded with too much information. As the rate of medical advances continues to accelerate, it is becoming extremely hard, if not impossible, for medical practitioners to keep track of all of the new drugs and devices that are available on the market. Companies that market to medical practitioners, such as pharmaceutical firms and medical device manufacturers, spend nearly $17.5 billion annually on physician marketing. However, because of the rapid pace of medical advances and the business of physicians, these companies are having a hard time competing for the attention of medical practitioners to make them aware of new drugs, devices and services that can potentially be used to treat a patient.

Hence, what is needed is a method or a system that facilitates informing medical practitioners about the drugs, devices and services that can be used in connection with treating a patient.

### SUMMARY

One embodiment of the present invention provides a system that serves advertisements within an electronic medical record (EMR) system. During operation, the system receives a request from a medical practitioner to access a patient-record from the EMR system. Next, the system looks up the patient-record in the EMR system and obtains one or more advertisements based information associated with the patient-record. The system then displays the one or more advertisements along with the patient-record to the medical practitioner.

In a variation on this embodiment, the system additionally receives a request from the medical practitioner to perform a search. In response to the request, the system performs the search to produce search results. Next, the system updates the one or more advertisements based on the search, and displays the one or more advertisements along with the search results to the medical practitioner.

In a variation on this embodiment, the system additionally receives a selection, by the medical practitioner, of an advertisement from the one or more advertisements. In response to the selection, the system navigates the medical practitioner to a web site associated with the advertisement. The system also facilitates collecting revenue from an advertiser based on the number of times the advertisement is selected.

In a variation on this embodiment, the system obtains the one or more advertisements by: obtaining keywords generated from the information associated with the patient-record; and using the keywords to lookup the one or more advertisements.

In a further variation, the system obtains the keywords by generating the keywords off-line from the information associated with the patient-record.

In a further variation, the system obtains the keywords by retrieving an encrypted token from the patient record, wherein the encrypted token contains the keywords in encrypted form. Furthermore, the system looks up the one or more advertisements by sending the encrypted token in a lookup request to an advertisement server. This allows the advertisement server to: (1) decrypt the keywords, (2) use the keywords to look up the one or more advertisements, and (3) to return the one or more advertisements.

In a variation on this embodiment, the information associated with the patient-record includes one or more of the following: (1) information about the patient associated with the patient record; (2) information associated with a search performed by the medical practitioner; (3) information about the medical practitioner; and (4) information about a hospital associated with the medical practitioner.

In a variation on this embodiment, the patient-record is obtained from a Personal History Record (PHR), which is maintained by a third-party system located outside of the EMR system.

In a variation on this embodiment, the information about the search includes: query terms for the search; search results generated by the search; and search results which are selected by the medical practitioner.

In a variation on this embodiment, the one or more advertisements suggest drugs, devices or other products and services that can be used in connection with treating a patient.

### BRIEF DESCRIPTION OF THE FIGURES

FIG. 1 illustrates a system that facilitates serving advertisements in an EMR system in accordance with an embodiment of the present invention.

FIG. 2 presents a flow chart illustrating the process of configuring an EMR system to serve advertisements in accordance with an embodiment of the present invention.

FIG. 3 presents a flow chart illustrating the process of displaying advertisements associated with a patient record in accordance with an embodiment of the present invention.

FIG. 4 presents a flow chart illustrating the process of displaying advertisements associated with a search operation in accordance with an embodiment of the present invention.

FIG. 5 presents a more-detailed view of the EMR system illustrated in FIG. 1 in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs), DVDs (digital versatile discs or digital video discs), or any device capable of storing data usable by a computer system.

### Overview

One embodiment of the present invention displays ads directly to doctors through an Electronic Medical Record (EMR) system, wherein the ads can be selected for a particular patient whose medical file is being reviewed. This embodiment operates by analyzing medical records to be associated with advertisements (ads) to determine “topics” within the medical records. When there is a match between topics from a medical record and an advertiser, the system identifies relevant ads, which are displayed in association with the medical record. Advertisers can pay for clicks on their ads, and the revenue from those clicks can be shared by the owner of the EMR system and the service provider. (Note that an EMR system generally contains any type of data that a medical provider maintains in its computer systems about a patient.)

While selecting ads for a patient, the system can analyze the medical record of the patient, as well as information about the medical practitioner and their employer. These ads can then be displayed through the EMR system along with the patient's medical record.

To improve conversion-tracking for advertisers, some medical providers may allow the system to include information in the ad-click that identifies the provider, and potentially the medical practitioner. The revenue from any clicks on those ads can then be shared by the ad service provider, the EMR vendor, and the medical provider.

In one embodiment of the present invention, the techniques which are used to analyze the medical record are based on identifying key terms in the medical record from a predefined medical ontology, in addition to the names of drugs and medical devices.

The present invention can be deployed in a number of ways. For example, the service provider can work with EMR vendors to provide them with software they can integrate with their EMR applications. This software would perform the EMR analysis to find key topics for advertisements, and would also query an advertising service to obtain ads associated with those keywords.

Alternatively, the service provider can leverage a PHR (Personal Healthcare Record) service. A PHR service is a service that enables a patient to control their own medical record. To use a PHR service, a patient gives the service provider the right to store a copy of their medical record, and to share their medical record with a medical provider. To serve an ad, the system analyzes the patient's PHR stored on the service provider's system to identify “key topics,” and then identifies targeted ads associated with these key topics. Next, the system includes the targeted ads along with the PHR data which is shared with medical providers. The ads are then displayed through EMR systems to medical practitioners.

For example, there exist many blood pressure medications that are commonly used, such as ACE inhibitors, and hydralazine is a particular blood pressure medication that is rarely used, except for pregnant women. One embodiment of the present invention identifies terms in a patient's medical record which indicate that the patient has high blood pressure and is pregnant. This allows an ad from a pharmaceutical firm that sells hydralazine to be displayed along with the patient's EMR. The medical practitioner who is viewing the patient's EMR can then be reminded by the advertisement to switch the patient to this type of blood-pressure medication. While hydralazine is currently a well-known drug, other less common drugs, or new drugs, that target specific combinations of conditions can also be advertised in this manner.

### Revenue Sharing

In one embodiment of the present invention, the ad service provider shares the revenue with the content providers, which in this case could either be the EMR vendor or the medical provider themselves. This can potentially turn EMR systems into revenue centers instead of cost centers for medical providers, while also: (1) increasing PHR adoption; (2) generating revenue for the ad service provider; and (3) providing incentives for EMR vendors to improve their systems.

A number of different models can be used for revenue sharing, and a few of these models are listed below:
1. EMR takes all—In this model the EMR system vendor receives all the revenue, but provides the EMR service/software free of charge to the medical provider. This minimizes risk for the medical provider.
2. Medical provider takes all—This is the opposite model in which the medical provider pays for the EMR service/software, but they also receive the advertising revenue. This maximizes the potential revenue for the medical provider. This model can also be used for groups like the Veteran's Administration who have built their own EMR systems.
3. Mixed—In this model, the EMR system vendor and the medical provider agree on an arrangement where the revenue is shared, and the EMR service/software is provided at some reduced rate. This allows a balance of risk/reward between both entities.

### Multi-Level Targeting

There are many ways in which the present invention can target ads for EMR/PHR systems, such as:
1. based solely on the page being displayed in the EMR record;
2. based on the patient's full EMR/PHR data;
3. based on the doctor's profile (specialty area, insurance they take, age, medical school, etc.); and
4. based on a combination of data from two or more of the above-noted sources.

### Conversion-Tracking

Since the end users of the system are employees of the medical provider, not patients, the medical provider can communicate information about the doctor or the hospital to the advertising service. This enables the advertising service to personalize ads better, and to track ad clicks. If the hospital allows this information to be passed on to the advertiser, then the advertiser can perform very detailed conversion-tracking, because they already have systems to track how much of their product is prescribed by particular hospital or doctor.

### Advertisers

The obvious advertisers are pharmaceutical firms and medical device manufacturers. However, there are many other potential advertisers, and the efficient targeting mechanism provided by the present invention should enable the creation of a “long tail” of such medical providers. For example, potential advertisers can include:
1. medical seminar providers;
2. medical journal publishers;
3. published papers that have a free abstract and then require payment to view;
4. insurance companies; and
5. medical consultants/specialists.

Insurance companies can potentially become a huge source of revenue because they could use these targeting methods to let doctors know about their preferences for treating a patient, such as reminding them to prescribe a particular drug instead of immediately scheduling the patient for a surgery. Moreover, the growing use of medical consultants/specialists can potentially improve the quality of medical care by fostering specialization, which is generally acknowledged to be one of the best ways to optimize quality. Unfortunately, in today's market it is difficult for medical specialists (whether they be individuals or medical groups) to market their services, so there are not as many of them as there could be.

### Privacy Concerns

Beyond the technical challenges, there are privacy concerns about the above-described advertising service. However, it should be possible for patients to request that this “feature” be disabled for their EMR system or their PHR system. However, insurance companies may raise premiums for patients who disable this feature.

### System

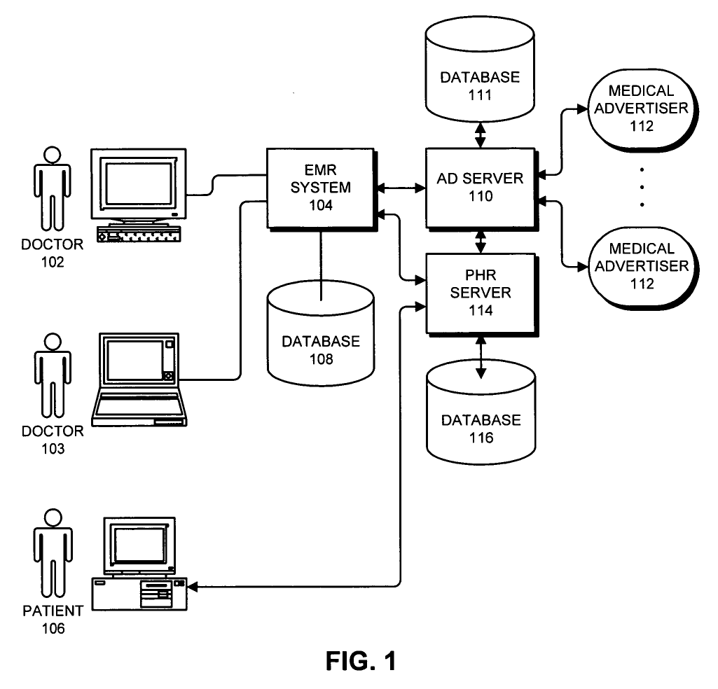

FIG. 1 illustrates a system that facilitates serving advertisements in an EMR system in accordance with an embodiment of the present invention. The system includes an EMR system 104 which belongs to a medical provider, such as a hospital. EMR system 104 can be accessed by medical practitioners, such as doctors 102-103. Note that EMR system 104 has its own database 108 for storing patient records and other information.

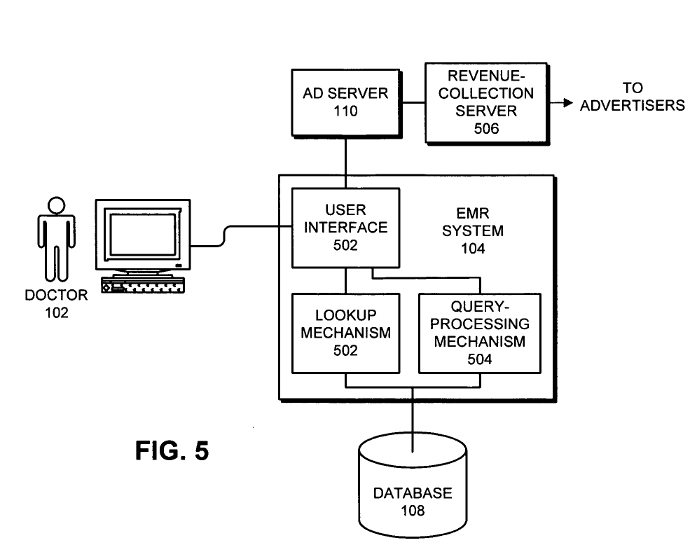

Referring to FIG. 5, EMR system 104 contains a user interface 502 which allows doctor 102 to communicate with EMR system 104. EMR system 104 additionally includes a lookup mechanism 502 configured to look up a patient-record in database 108, as well as a query-processing mechanism 404 configured to perform searches through medical records in database 108 to produce search results.

Referring back to FIG. 1, the system also includes a Personal Healthcare Record (PHR) server 114, which maintains medical records for patients in its own database 116. For example, in FIG. 1 a patient 106 can directly communicate with PHR server 114 to set up and to access a personal medical record. Furthermore, PHR server 114 allows patient 106 to selectively give permission to medical providers to share their medical record.

The system illustrated in FIG. 1 additionally includes an ad server 110, which communicates with EMR system 104 and PHR server 114. Ad server 110 facilitates displaying targeted ads for various medical advertisers 112-113 to users of EMR system 104. In doing so, ad server 110 retrieves ads from database 111 based on specific keywords. Ad server 110 also communicates with a revenue-collection server 506, which can send bills to advertisers as is illustrated in the FIG. 5.

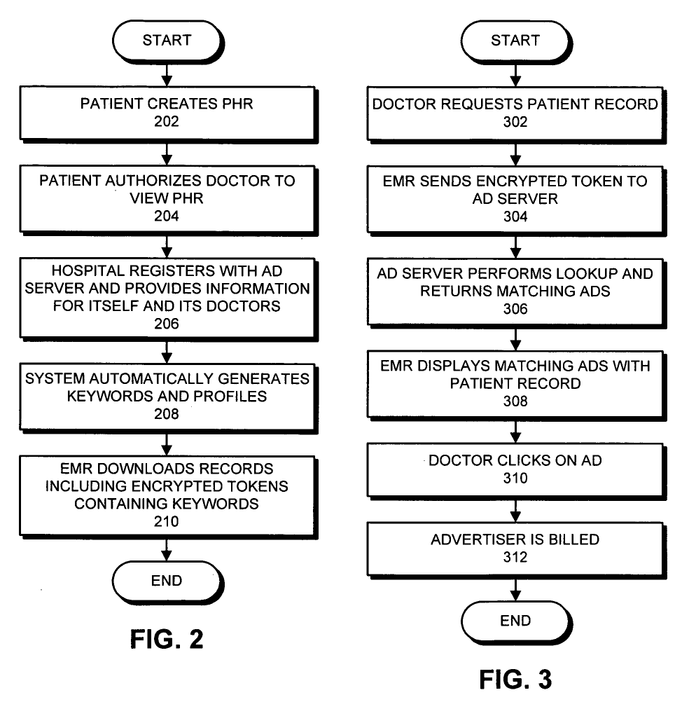

The process entire is described in more detail below with reference to the flow charts illustrated in FIGS. 2-4.

### Configuring the EMR System

FIG. 2 presents a flow chart illustrating the process of configuring an EMR system 104 to serve advertisements in accordance with an embodiment of the present invention. At the beginning of the process, a patient 106 communicates with PHR server 114 to create a PHR (step 202). This can involve self-entering data into the record, or obtaining a feed containing the data from a doctor or a hospital. Next, patient 106 authorizes a doctor or some other medical practitioner to view the PHR (step 204).

Also, the hospital which owns the EMR system 104 registers with the system, and in doing so provides information to ad server 110 about the hospital and doctors who work at the hospital to ad server 110 (step 206). (Note that ad server 110 can potentially be incorporated with PHR server 114 into a single system, or alternatively, ad server 110 and PHR server 114 can be implemented as separate servers as is illustrated in FIG. 1. Consequently, much of the functionality associated with the present invention can be implemented on either ad server 110 or PHR server 114. Hence, the term “system” as used in the following discussion can refer to ad server 110 or PHR server 114.)

Next, the system automatically generates keywords and profiles for PHRs as well as for hospitals and doctors (step 208). This process can take place periodically when the system is not busy, for example at night. In one embodiment of the present invention, these keywords can be associated with a specific document, such as a post to a user's medical record. Furthermore, there is a “profile” associated with a patient's full medical record containing keywords from the individual posts. In general, we use the term “profile” to refer to a set of keywords that applies to a group of associated documents. In the case of an EMR system, the profile is the set of keywords that best describe all the information in a user's medical record.

Finally, EMR system 104 downloads patient-records from PHR server 114 (step 210). In one embodiment of the present invention, these records hold encrypted tokens containing keywords associated with the records.

Note that keywords and profiles can be used for purposes other then serving ads. For example, if a doctor posts an entry to a patient's medical record that uses a very specific medical term, we can add a corresponding keyword to the record with a layperson's version of the term. Then, if the patient searches their medical record for posts about that layperson's version of the term, they will find the original post by the doctor. The profile can also be used when the patient uses a search engine to perform a search on a health topic. For example, if the profile for a patient indicates the patient is a senior citizen, the system can return search results which are personalized to their age group.

### Displaying Advertisements Associated with a Patient-Record

FIG. 3 presents a flow chart illustrating the process of displaying advertisements associated with a patient record in accordance with an embodiment of the present invention. At the beginning of this process, a doctor requests a patient-record through EMR system 104 (step 302). In response to this request, EMR system 104 looks up the patient record locally, and sends a profile or keywords in an encrypted token from the patient's record to ad server 110 (step 304).

In an alternative embodiment, EMR system 104 does not send the profile to ad server 110, but instead sends a numerical ID that can be mapped to the patient or to a specific document in the patient's record. Upon receiving this numerical ID, ad server 110 asks PHR server 114 to perform a lookup based on the numerical ID to produce a profile or keywords associated with that patient or document.

Next, ad server 110 performs a lookup in database 111 based on the keywords or profile. Note that database 111 stores ads with associated keywords to facilitate the lookup process. This lookup process retrieves ads that match the keywords, and ad server 110 returns these matching ads to EMR system 104 (step 306). The lookup can also be based on a profile for a medical provider, (which may specify, for example, that the medical group is group comprised of anesthesiologists) and a profile for the doctor (which may specify, for example, that the doctor is a recent medical graduate or a long time practicing physician). This enables the system to personalize ads based on the patient's profile, the doctor's profile, the hospital's profile and keywords for the medical post they are viewing.

In one embodiment of the present invention, the system stores sets of keywords associated with webpages that publish ads. The system then queries a “main ads system” to find relevant ads for those keywords.

Next, EMR system 104 displays the matching ads along with the patient record (step 308). The doctor can click on an ad, which causes the doctor to be directed to a website for a product in the ad (step 310). The advertiser can then be billed for the ad (step 312), which can involve billing for the display of the ad, or billing for each click-through, or each click-through which leads to a conversion (a sale).

### Displaying Advertisements Associated with a Search

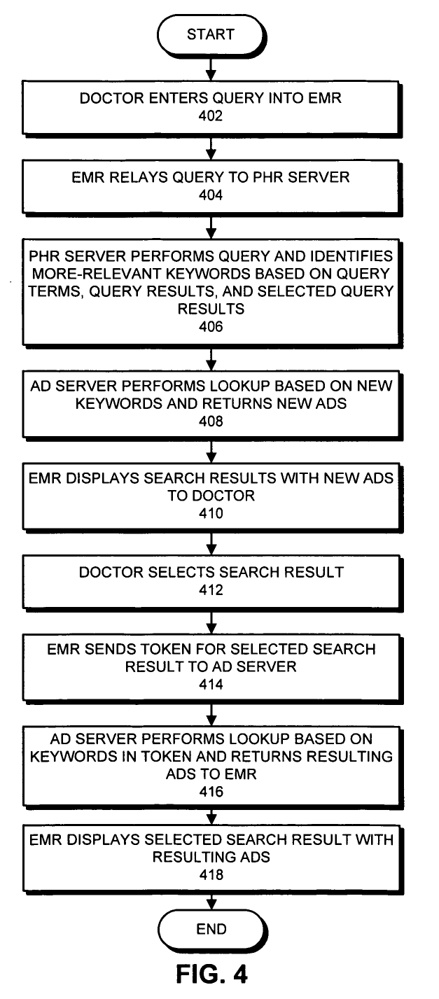

FIG. 4 presents a flow chart illustrating the process of displaying advertisements associated with a search operation in accordance with an embodiment of the present invention. First, a doctor 102 enters a query into EMR system 104 (step 402). Next, EMR system 104 relays the query to PHR server 114 (step 404).

PHR server 114 then performs the query, and in doing so identifies new and more-relevant keywords based on query terms, query results and selected query results (step 406).

Next, ad server 110 performs a lookup based on the new keywords and obtains new ads (step 408). The system then returns the new ads and the search results to EMR system 104, and EMR system 104 displays the new ads along with the search results to doctor 102 (step 410).

Doctor 102 can then click on a search result (step 412), which causes EMR system 104 to send a token for the selected search result to ad server 110 (step 414).

Next, ad server 110 performs to lookup based on keywords in the token and returns the resulting ads to EMR server 104 (step 416). This enables EMR server 104 to display the resulting ads along with the selected search result (step 418).

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for serving advertisements in an electronic medical record (EMR) system, comprising:
receiving a request from a medical practitioner to access a patient-record from the EMR system;
looking up the patient-record in the EMR system;
obtaining one or more advertisements based information associated with the patient-record; and
displaying the one or more advertisements along with the patient-record to the medical practitioner.

2. The method of claim 1, wherein the method further comprises:
receiving a request from the medical practitioner to perform a search;
performing the search to produce search results; and
updating the one or more advertisements based on the search and the search results; and
displaying the one or more advertisements along with the search results to the medical practitioner.

3. The method of claim 1, wherein the method further comprises:
receiving a selection, by the medical practitioner, of an advertisement from the one or more advertisements;
in response to the selection, navigating the medical practitioner to a web site associated with the advertisement; and
collecting revenue from an advertiser based on the number of times the advertisement is selected.

4. The method of claim 1, wherein obtaining the one or more advertisements involves:
obtaining keywords generated from the information associated with the patient-record; and
using the keywords to lookup the one or more advertisements.

5. The method of claim 4, wherein obtaining the keywords involves generating the keywords off-line from the information associated with the patient-record.

6. The method of claim 4,
wherein obtaining the keywords involves obtaining an encrypted token from the patient record, wherein the encrypted token contains the keywords in encrypted form; and
wherein using the keywords to lookup the one or more advertisements involves sending the encrypted token as part of a lookup request to an advertisement server, thereby allowing the advertisement server to decrypt the keywords, and to use the keywords to look up and return the one or more advertisements.

7. The method of claim 1, wherein the information associated with the patient-record includes one or more of the following:
information about the patient associated with the patient record;
information associated with a search performed by the medical practitioner;
information about the medical practitioner; and
information about a hospital associated with the medical practitioner.

8. The method of claim 7, wherein the patient-record is obtained from a Personal History Record (PHR), which is maintained by a third-party system located outside of the EMR system.

9. The method of claim 7, wherein the information about the search includes:
query terms for the search;
search results generated by the search; and
search results which are selected by the medical practitioner.

10. The method of claim 1, wherein the one or more advertisements suggest drugs, devices or other products and services that can be used in connection with treating a patient.

11. A computer-readable storage medium storing instructions that when executed by a computer cause the computer to perform a method for serving advertisements in an electronic medical record (EMR) system, the method comprising:
receiving a request from a medical practitioner to access a patient-record from the EMR system;
looking up the patient-record in the EMR system;
obtaining one or more advertisements based information associated with the patient-record; and
displaying the one or more advertisements along with the patient-record to the medical practitioner.

12. The computer-readable storage medium of claim 11, wherein the method further comprises:
receiving a request from the medical practitioner to perform a search;
performing the search to produce search results; and
updating the one or more advertisements based on the search and the search results; and
displaying the one or more advertisements along with the search results to the medical practitioner.

13. The computer-readable storage medium of claim 11, wherein the method further comprises:
receiving a selection, by the medical practitioner, of an advertisement from the one or more advertisements;
in response to the selection, navigating the medical practitioner to a web site associated with the advertisement; and
collecting revenue from an advertiser based on the number of times the advertisement is selected.

14. The computer-readable storage medium of claim 11, wherein obtaining the one or more advertisements involves:
obtaining keywords generated from the information associated with the patient-record; and
using the keywords to lookup the one or more advertisements.

15. The computer-readable storage medium of claim 14, wherein obtaining the keywords involves generating the keywords off-line from the information associated with the patient-record.

16. The computer-readable storage medium of claim 14,
wherein obtaining the keywords involves obtaining an encrypted token from the patient record, wherein the encrypted token contains the keywords in encrypted form; and
wherein using the keywords to lookup the one or more advertisements involves sending the encrypted token as part of a lookup request to an advertisement server, thereby allowing the advertisement server to decrypt the keywords, and to use the keywords to look up and return the one or more advertisements.

17. The computer-readable storage medium of claim 11, wherein the information associated with the patient-record includes one or more of the following:
information about the patient associated with the patient record;
information associated with a search performed by the medical practitioner;
information about the medical practitioner; and
information about a hospital associated with the medical practitioner.

18. The computer-readable storage medium of claim 17, wherein the patient-record is obtained from a Personal History Record (PHR), which is maintained by a third-party system located outside of the EMR system.

19. The computer-readable storage medium of claim 17, wherein the information about the search includes:
query terms for the search;
search results generated by the search; and
search results which are selected by the medical practitioner.

20. The computer-readable storage medium of claim 11, wherein the one or more advertisements suggest drugs, devices or other products and services that can be used in connection with treating a patient

21. An apparatus that serves advertisements in an electronic medical record (EMR) system, comprising:
an interface configured to receiving a request from a medical practitioner to access a patient-record from the EMR system;
a lookup mechanism configured to look up the patient-record in the EMR system; and
an advertisement-retrieving mechanism configured to retrieve one or more advertisements based information associated with the patient-record;
wherein the interface is additionally configured to display the one or more advertisements along with the patient-record to the medical practitioner.

22. The apparatus of claim 21,
wherein the interface is additionally configured to receive a request from the medical practitioner to perform a search;
wherein the apparatus additionally includes a query-processing mechanism configured to perform the search to produce search results; and
wherein the advertisement-retrieving mechanism is additionally configured to update the one or more advertisements based on the search and the search results; and
wherein the interface is configured to display the one or more advertisements along with the search results to the medical practitioner.

23. The apparatus of claim 21,
wherein the interface is additionally configured to receive a selection, by the medical practitioner, of an advertisement from the one or more advertisements;
wherein in response to the selection, the interface is configured to navigate the medical practitioner to a web site associated with the advertisement; and
wherein the apparatus additionally includes a mechanism for collecting revenue from an advertiser based on the number of times the advertisement is selected.
